(19) United States
(12) Patent Application Publication
(10) Pub. No.: US 2018/0330419 A1
(43) Pub. Date: Nov. 15, 2018

(54) Method and Apparatus of Providing Brand List Information

(71) Applicant: Alibaba Group Holding Limited, Grand Cayman (KY)

(72) Inventors: Wei Zhao, Zhejiang (CN); Luqi Wu, Zhejiang (CN); Wenxuan Lu, Zhejiang (CN)

(21) Appl. No.: 16/046,878

(22) Filed: Jul. 26, 2018

Related U.S. Application Data
(63) Continuation of application No. PCT/CN2017/071404, filed on Jan. 17, 2017.

(30) Foreign Application Priority Data
Jan. 27, 2016 (CN) 201610055773.9

(51) Int. Cl. G06Q 30/06

(52) U.S. Cl. CPC G06Q 30/0625

(57) ABSTRACT

A method and an apparatus for providing brand list information are provided. The method includes a server receiving a page access request; and providing a target page, the target page including a brand information list, the brand information list being used for displaying brand information of at least one brand, and the brand information including brand identification information and brand related data. Through the embodiments of the present disclosure, the effectiveness of information displayed in the brand information list can be improved.

### CROSS REFERENCE TO RELATED PATENT APPLICATIONS

This application claims priority to and is a continuation of PCT Patent Application No. PCT/CN2017/071404 filed on 17 Jan. 2017, and is related to and claims priority to Chinese Patent Application No. 201610055773.9, filed on 27 Jan. 2016, entitled “Method and Apparatus of Providing Brand List Information,” which are hereby incorporated by reference in their entirety.

### TECHNICAL FIELD

The present disclosure relates to the technical field of web page information processing, and particularly to methods and apparatuses for providing brand list information.

### BACKGROUND

With the rapid development of e-commerce systems today, e-commerce platforms are also advancing with time to provide users with product information and to meet a diversity of needs of the users. For example, with an entry of various brand merchants, an e-commerce platform can provide users with a collection of goods, and is no longer confined to stores opened by individual sellers, but rather stores opened by some brands such as brand flagship stores, specialty stores, etc. Compared with individual stores, brand flagship stores, specialty stores, etc. have higher guarantees in terms of product quality and service quality. Correspondingly, shopping habits of some buyers gradually change from searching for merchandise to searching for brand stores.

For this reason, some e-commerce sales platforms provide buying users with a brand list page, or a brand list section within a page (usually a page or section where a brand list is located is referred to as a “brand wall”). On the one hand, this brand list can bring together all brands that have settled in to showcase the richness of the brands in the platform. On the other hand, this brand list can also serve as an entry point for stores corresponding to specific brands, to help users to choose their favorite brands and enter corresponding stores for operations such as browsing, purchasing, etc. For example, brand information of a number of fast-fashion brands is usually displayed in a certain section to in a “Global fast-fashion” topic home page of “Tmall”.

In existing technologies, when brand information of each brand is displayed in a brand list of a page, mainly a “logo” (brand) and/or a brand name of each brand is displayed. A buying user chooses which specific brand store to enter for browsing or shopping through a personal awareness level of a logo or a name of a brand. However, individual perceptions of buying users often have limitations, and often lack patience for unknown issues. As a result, a click-through rate of each brand is more closely related to its own popularity. Apparently, some newly-listed brands or brands with relatively low popularity are relatively difficult to attract the attention of users. Accordingly, it is difficult to increase the traffic of associated stores, and brand information provided for these brands in a brand list cannot play its due role.

Therefore, how to improve the effectiveness of brand information in a brand list has become a technical problem that needs to be solved by one skilled in the art.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides a method and an apparatus of providing brand list information, which can improve the effectiveness of brand information displayed in a brand list.

The present disclosure provides the following solutions.

A method of providing brand list information includes a server receiving a page access request; and providing a target page, the target page including a brand information list, the brand information list being used for displaying brand information of at least one brand, and the brand information including brand identification information and brand related data.

A method of providing brand list information includes a second user client sending a page access request to a server; receiving a target page provided by the server, the target page including a brand information list, the brand information list being used for displaying brand information of at least one brand, and the brand information including brand identification information and brand related data; and displaying the target page.

An apparatus of providing brand list information, which is applied in a server, includes a request receiving unit used for receiving a page access request; and a target page provision unit used for providing a target page, the target page including a brand information list, the brand information list being used for displaying brand information of at least one brand, and the brand information including brand identification information and brand related data.

An apparatus of providing brand list information, which is applied a second user client, includes a request sending unit used for sending a page access request to a server; a target page receiving unit used for receiving a target page provided by the server, the target page including a brand information list, the brand information list being used for displaying brand information of at least one brand, and the brand information including brand identification information and brand related data; and a target page displaying unit used for displaying the target page.

According to specific embodiments provided by the present disclosure, the present disclosure discloses the following technical effects.

Through the embodiments of the present disclosure, when a brand information list is provided, related data of each brand may be provided in the list. As such, a second user can refer to the related data in the list to be guided to subsequent operations such as browsing, rather than just using identification information of a brand as a reference. Therefore, each brand can be allowed to obtain a more balanced opportunity to be browsed, and the effectiveness of information displayed in the brand information list is improved. In addition, the brand list can also be used to focus on the related data of each brand through this approach, and facilitate the second user to compare the related data of each brand, thereby guiding the second to user browse and to make a shopping decision for each brand more effectively.

Apparently, any product implementing the present disclosure does not need to achieve all of the above advantages at the same time.

### BRIEF DESCRIPTION OF THE DRAWINGS

In order to more clearly describe the technical solutions in the embodiments of the present disclosure, drawings used in the embodiments will be briefly described herein. Apparently, the drawings described herein represent only some embodiments of the applications. One skilled in the art can further obtain other drawings based on these drawings without making any creative effort.

FIG. 1 is a flowchart of a server method in accordance with the embodiments of the present disclosure.

FIGS. 2-1 and 2-2 are schematic diagrams of a page in accordance with the embodiments of the present disclosure.

FIG. 3 is a flowchart of a client method in accordance with the embodiments of the present disclosure.

FIG. 4 is a schematic diagram of a server apparatus in accordance with the embodiments of the present disclosure.

FIG. 5 is a schematic diagram of a client apparatus in accordance with the embodiments of the present disclosure.

### DETAILED DESCRIPTION

The technical solutions in the embodiments of the present disclosure are described clearly and completely herein with reference to the accompanying drawings in the embodiments of the present disclosure. Apparently, the described embodiments merely represent some and not all of the embodiments of the present disclosure. Based on the embodiments in the present disclosure, all other embodiments obtained by one of ordinary skill in the art shall fall in the scope of protection of the present disclosure.

In the embodiments of the present disclosure, in order to make brand information displayed in a brand list to play its proper role in a better manner, related data of a brand, which may be for example, discount information or new product information, etc., may be provided in addition to a logo, a name and other identification information of the brand. Alternatively, various types of information may be combined and then displayed as brand information in a brand list. In this way, when viewing the brand list, a second user (for example, a buying user, a consuming user, etc. in a platform) sees not only an identity of a brand, but also the related data of the brand. Accordingly, the second user can not only determine which brand of product to browse or buy based on a logo of a brand, but also make a comprehensive judgment based on a combination of individual related data, thus helping to bring traffic to more brands and improve the effectiveness of information displayed in the brand list. In addition, since the brand list has a characteristic of displaying multiple brands in a centralized manner, a focus can be made on related data of each brand through the brand list in this way, so that the second user can compare the related data of each brand, thus guiding the second user to browse and make a shopping decision for each brand in a more effective manner.

Exemplary implementations are described in detail hereinafter.

### First Embodiment

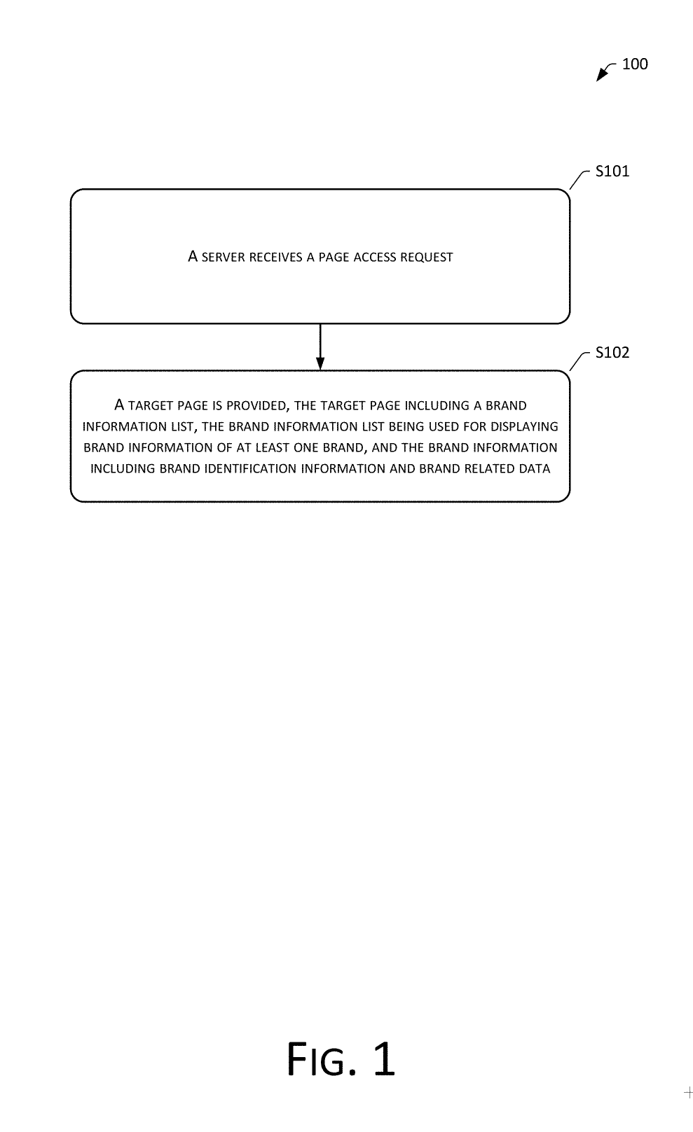

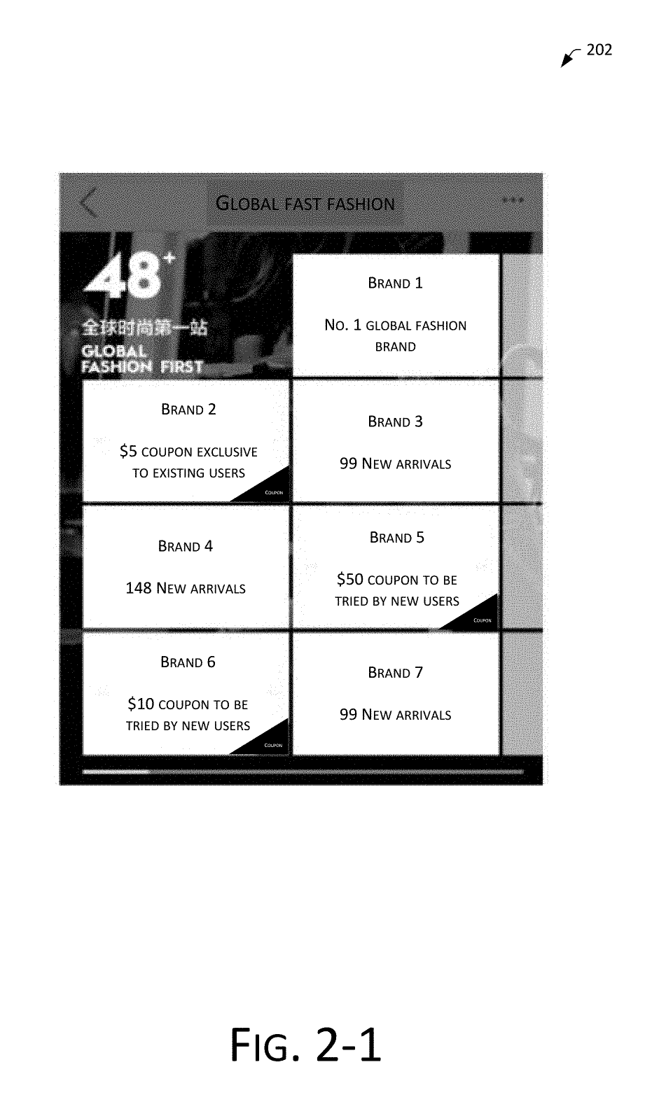

Referring to FIG. 1, this embodiment first provides a method 100 of providing brand list information from the perspective of a server. The method 300 may include the following operations.

S101: A server receives a page access request.

The page access request may be sent by a client of a second user to the server. Specifically, when the second user accesses a specific page through the client, the client may send a corresponding page access request to the server to obtain page data of the specific page. In a real application, the accessed page may be of multiple types. As long as a brand information list is included, corresponding data may be provided using the solutions in the embodiments of the present disclosure.

S102: A target page is provided, the target page including a brand information list, the brand information list being used for displaying brand information of at least one brand, and the brand information including brand identification information and brand related data.

After receiving the page access request, the server may provide a target page to the client. The target page includes a brand information list. When brand information of each brand is displayed in the brand information list, brand identification information and brand related data may be displayed.

What brand information is specifically displayed in brand list information may be determined according to requirements in a page in practice. For example, brand information of a plurality of brands may be categorically displayed in a brand list. Alternatively, in a real application, some brands may be aggregated in a brand information list for display because they have some common characteristics. For example, some brands are referred to as “fast fashion brands”, and information on individual brands belonging to fast fashion brands can be displayed on a same brand information list, for example.

Brand related data may include information in one or more of the following dimensions: discount information, new product information, and the like. The so-called discount information may refer to coupon information and the like provided by a brand store, which may be, for example, “5 dollars” coupon, a “10” dollar coupon, etc. In addition, some brand stores may also set specific applicable conditions for discount information. The specific application conditions may be set according to a request of a second user, or set according to an amount of consumption. Examples are “available for new users”, or “available when a total of 100 is consumed”, etc.

New product information may refer to product object information newly released in a brand store. In an exemplary implementation, since brand information is displayed in a brand information list, an area used for displaying the information is limited. Therefore, the new product information in the embodiments of the present disclosure may include information such as a quantity of new products. Alternatively, in other implementations, information such as representative pictures of new products, etc., may also be extracted.

It should be noted that, in the embodiments of the present disclosure, each brand in a brand information list may be a “fast fashion brand”. Distinguishing feature of such brands are a fair price, a fast update speed, and a fashion trend. Therefore, according to the embodiments of the present disclosure, the brand related data displayed in the brand information list may be related to the brand characteristics as described above. When specific related data of brands is provided in the brand information list, since an information display area corresponding to each brand is limited, only related data in some dimensions may be provided. For this purpose, corresponding priority information may also be provided for each dimension of related data. For example, if related data on the multiple dimensions includes a dimension of discount information, a dimension of new product information, and the like, the dimension of discount information may be set to a high priority, and a low priority is set to the dimension of new product information, etc. When related data of a brand is provided, related data of a dimension having a high priority may be preferentially provided. If a brand does not have related data in a dimension having a high priority, related data in a dimension with a lower priority may be obtained. For example, a determination may first be made as to whether a brand has discount information. If the discount information exists, the discount information can be used as related data displayed in the brand information list. If no discount information exists, a determination can be made as to whether new product information exists for the brand. If the new product information exists, the new product information can be used as related data displayed in the brand information list. Apparently, in practical applications, a priority in each dimension may also have other setting methods, which are not described in detail herein.

Apparently, in practical applications, related data often have time-phased characteristics. For example, a certain brand offers some kind of discount within a certain period of time, or new products are released within a certain period of time, etc. Therefore, when brand information is displayed in the brand list, a situation in which a brand does not currently have related data may exist. In order to improve the effectiveness of information in the brand list, brand positioning description text information may also be provided in the brand list in response to this situation. In other words, this type of brand positioning description text information may be added to the brand information, and shown in the brand list. This brand positioning description text information refers to descriptive information that has a descriptive effect on aspects such brand positioning, which may be for example, slogan information that a brand merchant puts forward according to a positioning of the brand, such as “French fashion brand, bold innovation”, or “No. 1 Global Fashion Brand”, etc.

In an exemplary implementation, information specifically displayed in the brand information list in the target page may be preset, or may be generated after the server receives the access request and reads the specific brand related data, for example.

For the latter case, the server may first determine associated brands in the brand information list, obtain related data of each brand from a brand information database, and then obtain the related data of each brand from a database which may include the brand information database and may also include a product object information database. The brand information database is used for storing brand-related information, such as discount information, brand description information, and the like. The product object information database may include detailed information of product objects, including a release time, whether it is a new product, and the like. Specific data in the brand information database may be provided by first users (e.g., merchant users, etc.) and stored by the server in a database system. Data in the product object information database may also be stored according to data submitted by the first users, or may be stored in the product object information database after statistics are made on actual sales situations of the product objects.

For example, a manner of storing information in the brand information database may be represented by Table 1 as follows.

TABLE 1

| Brand ID | Discount information | Brand description information |
|---|---|---|
| 10001 | $5 coupon, exclusive to | No. 1 global fashion brand |
| | existing users | |
| 10002 | $50 coupon, tried by new | French fashion brand, bold |
| | users | innovation |
| 10003 | $10 coupon, exclusive to | Global brand specialized for |
| | new users | underwear |
| . . . | . . . | . . . |

For example, a manner of storing information in the product object information database may be represented by Table 2 as follows.

TABLE 2

| Product | | Product object | Is a new |
|---|---|---|---|
| object ID | Brand ID | release time | product |
| 20001 | 10001 | X year X month X day | Yes |
| 20002 | 10001 | X year X month X day | No |
| 20003 | 10001 | X year X month X day | yes |
| | . . . | . . . | . . . |

Specifically, during an acquisition of discount information of brands, the server may determine whether discount information for a brand exists according to the brand information database. If exists, the server may extract a discounted amount and/or applicable condition information of the discount information, and determine related data of the brand. During an acquisition of new product information of brands, a determination can be made as to whether a product object marked as a new product according to information of the product object information database associated with the brands. If exists, a quantity of product objects marked as new products in the same brand can be counted, and the quantity is taken as related data of the brand. Alternatively, representative pictures of the product objects are extracted from the product objects marked as the new products, and the representative pictures are taken as the related data of the brand. A new product tag may be added by the server in the product object information database when a product object is released, and the server may set a deadline for the new product in advance. For example, a product having a release date within one month is called a new product, and a tag thereof is automatically deleted after more than one month. When representative pictures of new products are extracted, if multiple new products exist in a brand, a product object may be selected therefrom by means of a random selection, for example, and a representative picture of that product object is taken as related data to be displayed. Which picture is used as a representative picture for a product object may be specified when the product object is released, or may be determined and recorded in the product object information database in other manners. In addition, when brand positioning description text information of a brand is to be obtained, the brand positioning description text information of the brand can be directly read from the brand information database.

In short, through the embodiments of the present disclosure, when a brand information list is provided, related data of each brand may be provided in the list. As such, a second user can refer to the related data in the list to be guided for subsequent operations such as browsing, rather than just using identification information of the brands as a reference. Therefore, various brands can be given more balanced opportunities to be browsed and the effectiveness of the information displayed in the brand information list can be improved. In addition, the brand list can also be used to focus on the related data of each brand in this way, so that the second user can compare the related data of each brand, thereby guiding the second user browse and to make a shopping decision for each brand more effectively.

It should be noted that in the embodiments of the present disclosure, a terminal device where the client of the second user is located may be a mobile terminal device such as a mobile phone. Given that a screen of the mobile terminal device is limited in size, the number of brands displayed in a brand information list may be large. Therefore, in real applications, various brands in the brand information list can be displayed on split screens.

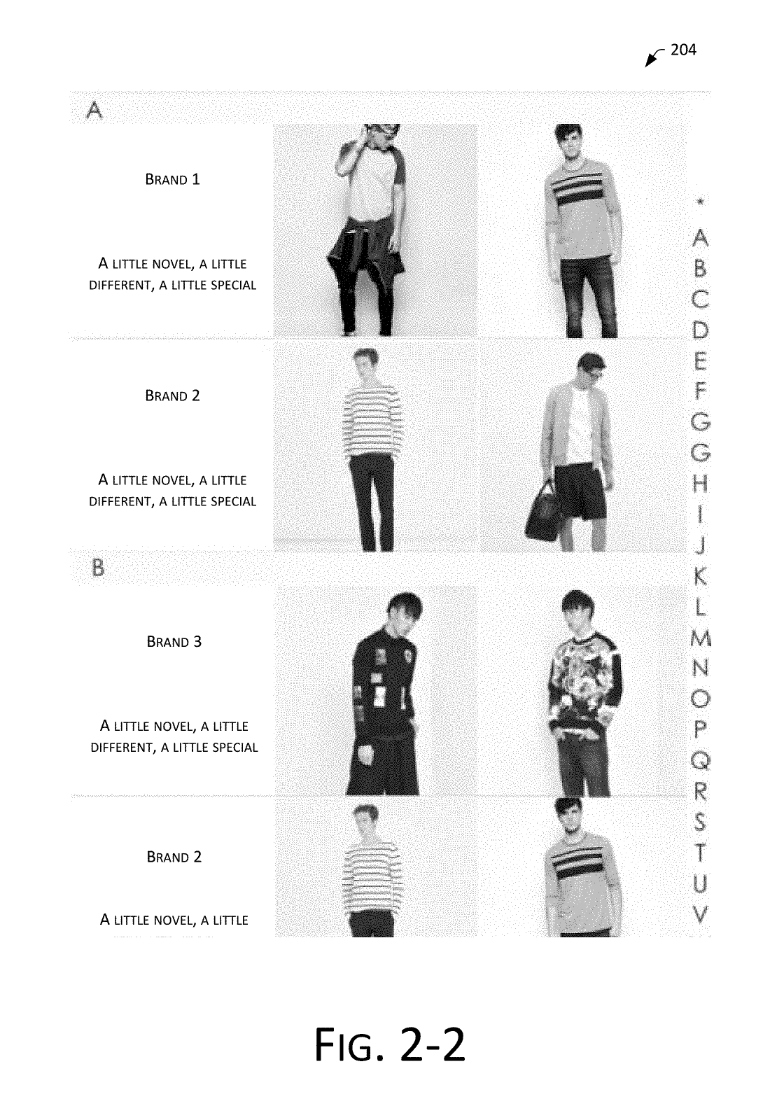

For example, FIG. 2-1 is a sketch of a display effect of a target page 202 according to the embodiments of the present disclosure. As can be seen, a brand information list includes brand information of multiple brands, in which the brand information of each brand includes an identifier and related data of the respective brand. Related data of brand 1 is “No. 1 global fashion brand”, related data of brand 2 is “$5 coupon, exclusive to existing users”, and related data of brand 3 is “99 new arrivals” etc. FIG. 2-1 shows brand information in one screen, which displays brand information of seven brands. Other brand information that has not yet been displayed can be moved to a visual range of a window by sliding in left or right direction, for example.

Alternatively, referring to FIG. 2-2, when brand list information 204 is displayed, each brand may also correspond to a horizontal strip display position. As such, an information display position area of each brand increases relative to FIG. 2-1. When new product information is displayed, one or more representative pictures of new products may be displayed. In addition, for each brand, brand information in multiple dimensions can be displayed at the same time. For example, in FIG. 2-2, other than displaying representative pictures of new products of a brand, brand positioning description text information, such as “a little novel, a bit different and a bit special”, etc., can also be displayed.

In addition, it should be noted that an order of various brands may also be set in the brand information list according to the embodiments of the present disclosure. Specifically, multiple ways of ordering can exist. For example, ordering may be made based on data such as popularity, sales volume, or the like of each brand. Alternatively, in the embodiments of the present disclosure, a determination may also be made according to the relevance of each brand to a current second user, which may make information of a brand that is more concerned by the second user to be displayed the second user more preferentially. In an exemplary implementation, a correlation between a second user and a certain brand may be determined through statistics of historical activity data of the second user. The historical activity data may include browsing activity data, purchasing activity data, and collection behavior data, etc., of the second user. A respective correlation between each brand and the second user may be calculated. This type of correlation may reflect information such as a respective degree of preference of the second user for each brand. In this way, the effectiveness of information can be further improved. In addition, the brand list can also be used to focus on related data of each brand through this approach, to facilitate the second user to make comparison among the related data of each brand, thereby guiding the second user to browse and make a shopping decision for each brand in a more effective manner.

### Second Embodiment

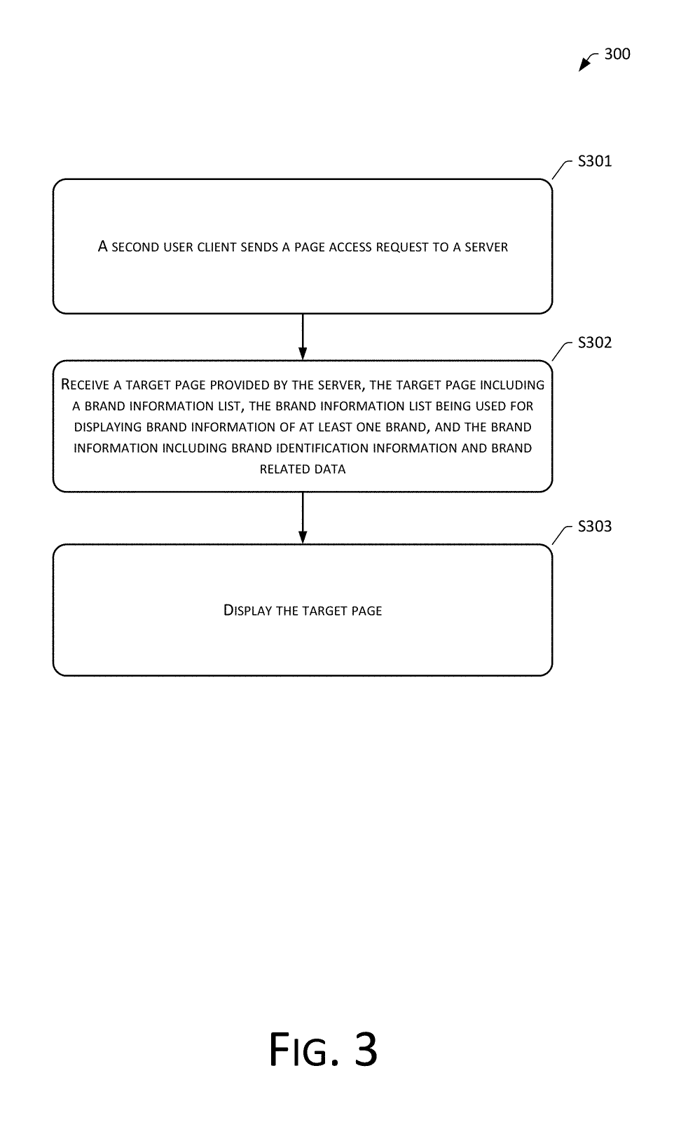

The second embodiment is in correspondence with the first embodiment, and provides a method 300 of providing brand list information from the perspective of a second user client. Referring to FIG. 3, the method 300 may include the following operations.

S301: A second user client sends a page access request to a server.

S302: Receive a target page provided by the server, the target page including a brand information list, the brand information list being used for displaying brand information of at least one brand, and the brand information including brand identification information and brand related data.

S303: Display the target page.

Details of implementations of the second embodiment can be referenced to description of the first embodiment, and are not redundantly described herein.

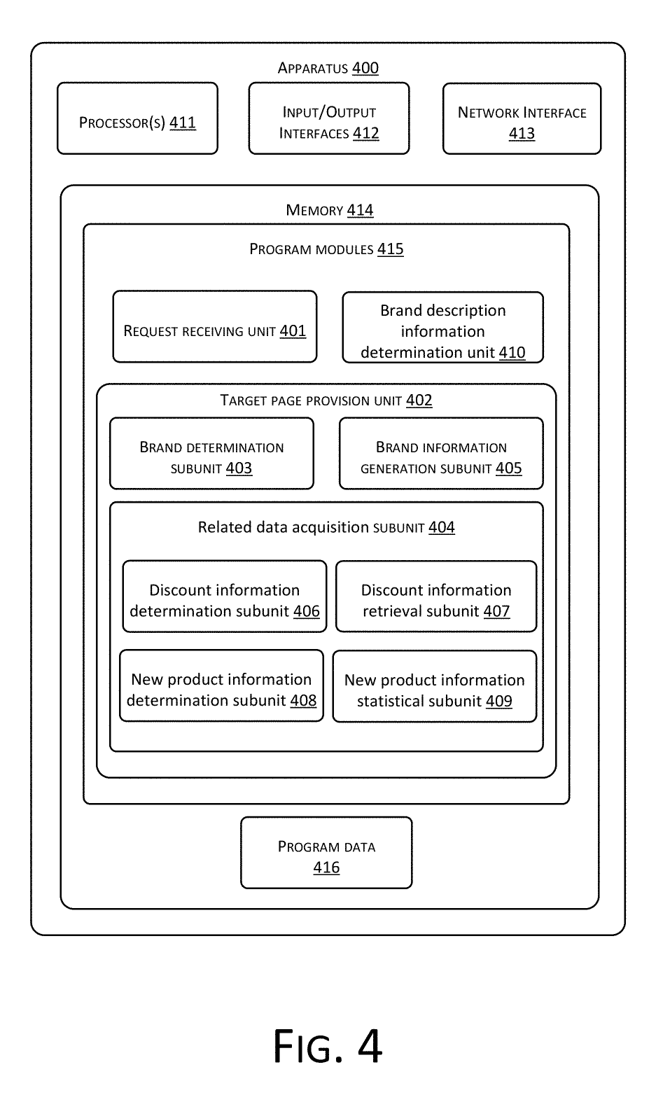

Corresponding to the method of providing brand list information in accordance with the first embodiment, the embodiments of the present disclosure also provide an apparatus 400 of providing brand list information. The apparatus 400 is applied in a server. In implementations, the apparatus 400 may include one or more computing devices. In implementations, the apparatus 400 may be a part of one or more computing devices, e.g., implemented or run by the one or more computing devices. In implementations, the one or more computing devices may be located in a single place or distributed among a plurality of network devices over a network. By way of example and not limitation, referring to FIG. 4, the apparatus 400 may specifically include a request receiving unit 401 used for receiving a page access request; and a target page provision unit 402 used for providing a target page, the target page including a brand information list, the brand information list being used for displaying brand information of at least one brand, and the brand information including brand identification information and brand related data.

The brand related data includes discount information and/or new product information.

In an exemplary implementation, the target page provision unit 402 may include a brand determination subunit 403 used for determining related brands in the brand information list; a related data acquisition subunit 404 used for obtaining related data of each brand from a database; and a brand information generation subunit 405 used for generating the brand information using the related data that is obtained.

The related data may include brand discount information, and the related data acquisition subunit 404 includes a discount information determination subunit 406 used for determining whether discount information exists for a respective brand according to a brand information database; and a discount information retrieval subunit 407 used for retrieving and determining a discounted amount and/or applicable condition information for the discount information as the related data of the respective brand if the discount information exists.

The related data may also include new product information of brand(s), and the related data acquisition subunit 404 includes a new product information determination subunit 408 used for determining whether a product object labeled as a new product exists according to a product object database associated with the brand(s); and a new product information statistical subunit 409 used for counting a number of product objects within a same brand that are labeled as new products, and setting the number of the new products as related data of the brand if new product information exists.

Furthermore, the apparatus 400 may also include a brand description information determination unit 410 used for determining brand positioning description text information of the brand according to a brand information database, and adding the brand positioning description text information into the brand information.

The database includes related data in a plurality of dimensions, and different dimensions corresponding to different priorities.

The related data acquisition subunit 404 is specifically used for preferentially obtaining related data in a dimension having a high priority from the database, and obtaining related data in a dimension of a lower priority if no related data exists in the dimension of the high priority.

In an exemplary implementation, a display order of various brands in the brand information list may be determined based on relevance with a second user.

Relevance between the second user and a certain brand is determined using statistics of historical activity data of the second user.

Furthermore, the various brands in the brand information list are displayed in split screens.

In implementations, the service processing apparatus 400 may also include one or more processors 411, an input/output (I/O) interface 412, a network interface 413, and memory 414.

The memory 414 may include a form of computer readable media such as a volatile memory, a random access memory (RAM) and/or a non-volatile memory, for example, a read-only memory (ROM) or a flash RAM. The memory 414 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 414 may include program modules 415 and program data 416. The program modules 415 may include one or more of the foregoing units/subunits as described in FIG. 4.

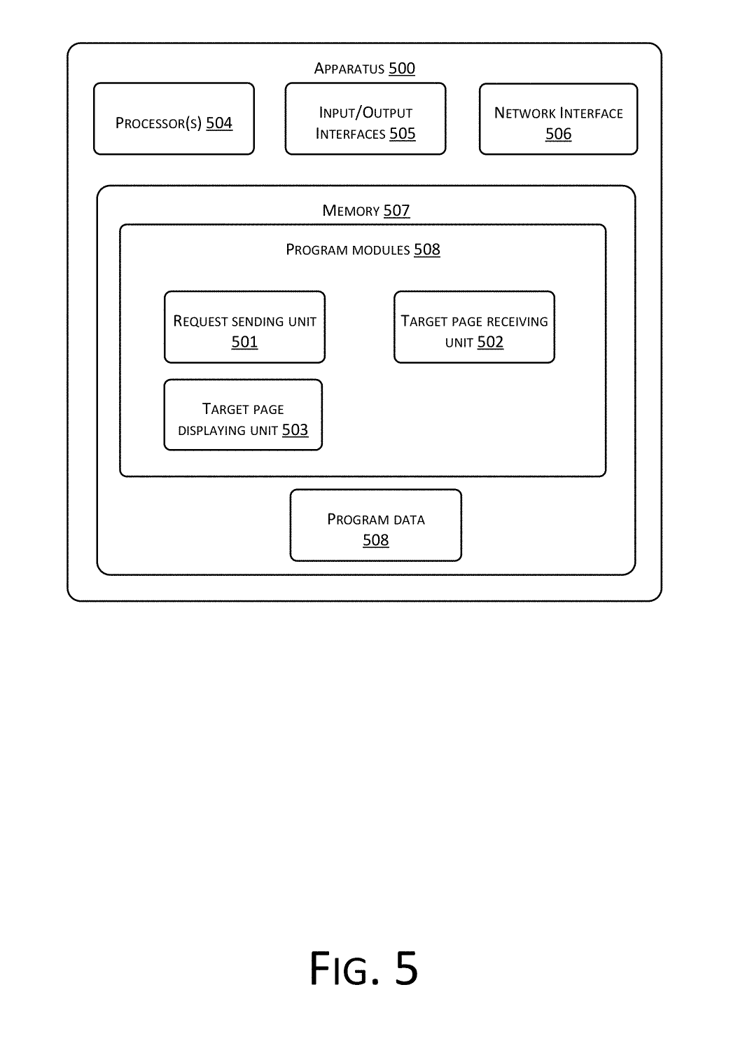

Corresponding to the method of providing brand list information in accordance with the second embodiment, the embodiments of the present disclosure also provide an apparatus 500 of providing brand list information. The apparatus 500 is applied in a user client. In implementations, the apparatus 500 may include one or more computing devices. In implementations, the apparatus 500 may be a part of one or more computing devices, e.g., implemented or run by the one or more computing devices. In implementations, the one or more computing devices may be located in a single place or distributed among a plurality of network devices over a network. By way of example and not limitation, referring to FIG. 5, the apparatus 500 may specifically include a request sending unit 501 used for sending a page access request to a server; a target page receiving unit 502 used for receiving a target page provided by the server, the target page including a brand information list, the brand information list being used for displaying brand information of at least one brand, and the brand information including brand identification information and brand related data; and a target page displaying unit 503 used for displaying the target page.

In implementations, the apparatus 500 may also include one or more processors 504, an input/output (I/O) interface 505, a network interface 506, and memory 507.

The memory 507 may include a form of computer readable media as described in the foregoing description. In implementations, the memory 507 may include program modules 508 and program data 509. The program modules 509 may include one or more of the foregoing units/subunits as described in FIG. 5.

Through the embodiments of the present disclosure, when a brand information list is provided, related data of each brand may be provided in the list. As such, a second user can refer to the related data in the list to be guided to subsequent operations such as browsing, rather than just using identification information of a brand as a reference. Therefore, each brand can be allowed to obtain a more balanced opportunity to be browsed, and the effectiveness of information displayed in the brand information list is improved. In addition, the brand list can also be used to focus on the related data of each brand through this approach, and facilitate the second user to compare the related data of each brand, thereby guiding the second to user browse and to make a shopping decision for each brand more effectively.

As can be known from the description of the above embodiments, one skilled in the art can clearly understand that the present disclosure can be implemented by means of software plus a necessary universal hardware platform. Based on this understanding, an essence of the technical solutions of the present disclosure or portions contributing to existing technologies can be embodied in a form of a software product. This computer software product that can be stored in a storage media such as ROM/RAM, a magnetic disk, an optical disk, or the like, and includes instructions to cause a computing device (which may be a personal computer, a server, or a network device, etc.) to perform the method described in each embodiment or certain portions of an embodiment of the present disclosure.

Each embodiment in the present specification is described in a progressive manner. The same or similar parts among the embodiments can be referenced to each other. Each embodiment has a focus that is different from those of other embodiments. In particular, due to their basic similarities to the method embodiments, the description of the systems or system embodiments is relatively simple, and related parts may be referenced to the description of respective parts of the method embodiments. The systems and the system embodiments described above are only illustrative, in which units that are described as separate components may or may not be physically separated. Components that are presented as units may or may not be physical units, i.e., may be located in one place, or can be distributed among multiple network units. Some or all of the modules may be selected according to actual needs to achieve the purpose of the present solutions of the embodiments. One of ordinary skill in the art can understand and implement without making any creative efforts

The methods and the apparatuses of providing brand list information provided in the present disclosure have been described in detail above. Specific examples are used in this document to illustrate the principles and ways of implementation of the present disclosure. The above embodiments are only used for helping to understand the methods and core ideas of the present disclosure. One of ordinary skill in the art can make changes to the exemplary implementations and scopes of application according to the ideas of the present disclosure. In summary, the content of the present specification should not be construed as limitations to the present disclosure.

The present disclosure can be further understood using the following clauses.

Clause 1: A method of providing brand list information, comprising: a server receiving a page access request; and providing a target page, the target page including a brand information list, the brand information list being used for displaying brand information of at least one brand, and the brand information including brand identification information and brand related data.

Clause 2: The method of Clause 1, wherein the brand related data comprises discount information and/or new product information.

Clause 3: The method of Clause 1, wherein providing the target page comprises: determining related brands in the brand information list; obtaining related data of each brand from a database; and generating the brand information using the related data that is obtained.

Clause 4: The method of Clause 3, wherein the related data comprises brand discount information, and obtaining the related data of each brand from the database comprises: determining whether discount information exists for a respective brand according to a brand information database; and retrieving and determining a discounted amount and/or applicable condition information for the discount information as related data of the respective brand if the discount information exists.

Clause 5: The method of Clause 3, wherein the related data comprises brand new product information, and obtaining the related data of each brand from the database comprises: determining whether a product object labeled as a new product exists according to a product object database associated with a respective brand; and obtaining information of the product object labeled as the new product to serve as the related data of the respective brand if affirmative.

Clause 6: The method of Clause 6, wherein obtaining the information of the product object labeled as the new product comprises counting a number of product objects within a same brand that are labeled as new products, and setting the number of the new products as the related data of the brand.

Clause 7: The method of Clause 5, wherein obtaining the information of the product object labeled as the new product comprises extracting a representative picture from the product object labeled as the new product, and setting the representative picture as the related data of the brand.

Clause 8: The method of Clause 3, further comprising determining brand positioning description text information of the brand according to a brand information database, and adding the brand positioning description text information into the brand information.

Clause 9: The method of any one of Clauses 3-8, wherein the database comprises related data in multiple dimensions, different dimensions correspond to different priorities, and obtaining the related data of each brand from the database comprises preferentially obtaining related data in a dimension having a high priority from the database, and obtaining related data in a dimension of a lower priority if no related data exists in the dimension of the high priority.

Clause 10: The method of any one of Clauses 1-8, wherein a display order of each brand in the brand information list is determined based on respective relevance with a second user.

Clause 11: The method of Clause 10, wherein relevance between the second user and a certain brand is determined using statistics of historical activity data of the second user.

Clause 12: The method of any one of Clauses 1-8, wherein various brands in the brand information list are displayed in split screens.

Clause 13: A method of providing brand list information, comprising: a second user client sending a page access request to a server; receiving a target page provided by the server, the target page including a brand information list, the brand information list being used for displaying brand information of at least one brand, and the brand information including brand identification information and brand related data; and displaying the target page.

Clause 14: An apparatus of providing brand list information, which is applied in a server, comprising: a request receiving unit used for receiving a page access request; and a target page provision unit used for providing a target page, the target page including a brand information list, the brand information list being used for displaying brand information of at least one brand, and the brand information including brand identification information and brand related data.

Clause 15: The apparatus of Clause 14, wherein the brand related data comprises discount information and/or new product information.

Clause 16: The apparatus of Clause 14, wherein the target page provision unit comprises: a brand determination subunit used for determining related brands in the brand information list; a related data acquisition subunit used for obtaining related data of each brand from a database; and a brand information generation subunit used for generating the brand information using the related data that is obtained.

Clause 17: The apparatus of Clause 16, wherein the related data comprises brand discount information, and the related data acquisition subunit comprises: a discount information determination subunit used for determining whether discount information exists for a respective brand according to a brand information database; and a discount information retrieval subunit used for retrieving and determining a discounted amount and/or applicable condition information for the discount information as related data of the respective brand if the discount information exists.

Clause 18: The apparatus of Clause 16, wherein the related data comprises brand new product information, and the related data acquisition subunit comprises: a new product information determination subunit used for determining whether a product object labeled as a new product exists according to a product object database associated with a respective brand; and a new product information statistical subunit used for counting a number of product objects within a same brand that are labeled as new products, and obtaining information of the product object labeled as the new product to serve as the related data of the respective brand if affirmative.

Clause 19: The apparatus of Clause 18, wherein the new product information statistical subunit is specifically used for counting a number of product objects within a same brand that are labeled as new products, and setting the number of the new products as the related data of the brand.

Clause 20: The apparatus of Clause 18, wherein new product information statistical subunit is specifically used for extracting a representative picture from the product object labeled as the new product, and setting the representative picture as the related data of the brand.

Clause 21: The apparatus of Clause 16, further comprising a brand description information determination unit used for determining brand positioning description text information of the brand according to a brand information database, and adding the brand positioning description text information into the brand information.

Clause 22: The apparatus of any one of Clauses 16-21, wherein the database comprises related data in multiple dimensions, different dimensions correspond to different priorities, and the related data acquisition unit is specifically used for preferentially obtaining related data in a dimension having a high priority from the database, and obtaining related data in a dimension of a lower priority if no related data exists in the dimension of the high priority.

Clause 23: The apparatus of any one of Clauses 16-21, wherein a display order of each brand in the brand information list is determined based on respective relevance with a second user.

Clause 24: The apparatus of Clause 23, wherein relevance between the second user and a certain brand is determined using statistics of historical activity data of the second user.

Clause 25: The apparatus of any one of Clauses 14-21, wherein various brands in the brand information list are displayed in split screens.

Clause 26: An apparatus of providing brand list information, which is applied a second user client, comprising: a request sending unit used for sending a page access request to a server; a target page receiving unit used for receiving a target page provided by the server, the target page including a brand information list, the brand information list being used for displaying brand information of at least one brand, and the brand information including brand identification information and brand related data; and a target page displaying unit used for displaying the target page.

What is claimed is:

1. A method implemented by a server running on one or more computing devices, the method comprising:
receiving a page access request; and
providing a target page, the target page including a brand information list, the brand information list being used for displaying brand information of at least one brand, and the brand information including brand identification information and brand related data.

2. The method of claim 1, wherein the brand related data comprises at least one of discount information or new product information.

3. The method of claim 1, wherein providing the target page comprises:
determining related brands in the brand information list;
obtaining related data of each brand from a database; and
generating the brand information using the related data that is obtained.

4. The method of claim 3, wherein the related data comprises brand discount information, and obtaining the related data of each brand from the database comprises:
determining whether discount information exists for a respective brand according to a brand information database; and
retrieving and determining a discounted amount and/or applicable condition information for the discount information as related data of the respective brand if the discount information exists.

5. The method of claim 3, wherein the related data comprises brand new product information, and obtaining the related data of each brand from the database comprises:
determining whether a product object labeled as a new product exists according to a product object database associated with a respective brand; and
obtaining information of the product object labeled as the new product to serve as the related data of the respective brand if affirmative.

6. The method of claim 5, wherein obtaining the information of the product object labeled as the new product comprises counting a number of product objects within a same brand that are labeled as new products, and setting the number of the new products as the related data of the brand.

7. The method of claim 5, wherein obtaining the information of the product object labeled as the new product comprises extracting a representative picture from the product object labeled as the new product, and setting the representative picture as the related data of the brand.

8. The method of claim 3, further comprising determining brand positioning description text information of the brand according to a brand information database, and adding the brand positioning description text information into the brand information.

9. The method of claim 3, wherein the database comprises related data in multiple dimensions, different dimensions correspond to different priorities, and obtaining the related data of each brand from the database comprises preferentially obtaining related data in a dimension having a high priority from the database, and obtaining related data in a dimension of a lower priority if no related data exists in the dimension of the high priority.

10. The method of claim 1, wherein a display order of each brand in the brand information list is determined based on respective relevance with a second user.

11. The method of claim 10, wherein relevance between the second user and a certain brand is determined using statistics of historical activity data of the second user.

12. The method of claim 1, wherein various brands in the brand information list are displayed in split screens.

13. One or more computer readable media storing executable instructions that, when executed by one or more processors, cause the one or more processors to perform acts comprising:
sending a page access request to a server;
receiving a target page provided by the server, the target page including a brand information list, the brand information list being used for displaying brand information of at least one brand, and the brand information including brand identification information and brand related data; and
displaying the target page.

14. An apparatus comprising:
one or more processors;
memory;
a request receiving unit stored in the memory and executable by the one or more processors to receive a page access request; and
a target page provision unit stored in the memory and executable by the one or more processors to provide a target page, the target page including a brand information list, the brand information list being used for displaying brand information of at least one brand, and the brand information including brand identification information and brand related data.

15. The apparatus of claim 14, wherein the target page provision unit comprises:
a brand determination subunit used for determining related brands in the brand information list;
a related data acquisition subunit used for obtaining related data of each brand from a database; and
a brand information generation subunit used for generating the brand information using the related data that is obtained.

16. The apparatus of claim 15, wherein the related data comprises brand discount information, and the related data acquisition subunit comprises:
a discount information determination subunit used for determining whether discount information exists for a respective brand according to a brand information database; and
a discount information retrieval subunit used for retrieving and determining a discounted amount and/or applicable condition information for the discount information as related data of the respective brand if the discount information exists.

17. The apparatus of claim 15, wherein the related data comprises brand new product information, and the related data acquisition subunit comprises:
a new product information determination subunit used for determining whether a product object labeled as a new product exists according to a product object database associated with a respective brand; and
a new product information statistical subunit used for counting a number of product objects within a same brand that are labeled as new products, and obtaining information of the product object labeled as the new product to serve as the related data of the respective brand if affirmative.

18. The apparatus of claim 17, wherein the new product information statistical subunit is specifically used for counting a number of product objects within a same brand that are labeled as new products, and setting the number of the new products as the related data of the brand.

19. The apparatus of claim 17, wherein new product information statistical subunit is specifically used for extracting a representative picture from the product object labeled as the new product, and setting the representative picture as the related data of the brand.

20. The apparatus of claim 15, further comprising a brand description information determination unit used for determining brand positioning description text information of the brand according to a brand information database, and adding the brand positioning description text information into the brand information.
